(19) United States
(12) Patent Application Publication
(10) Pub. No.: US 2009/0071234 A1
(43) Pub. Date: Mar. 19, 2009

(54) INSTALLATION FOR MOISTURE DETECTION FOR MOTOR VEHICLES

(75) Inventors: Andreas Blaut, Unna (DE); Heiko Schafer, Erwitte (DE); Franz-Josef Schmidt, Salzkotten (DE)

Correspondence Address: HUSCH BLACKWELL SANDERS LLP, 190 CARONDELET PLAZA, SUITE 600, ST. LOUIS, MO, 63105-3441, US

(73) Assignee: HELLA KGAA HUECK & CO., Lippstadt (DE)

(21) Appl. No.: 11/915,106

(22) PCT Filed: May 17, 2006
(86) PCT No.: PCT/EP2006/062359

§ 371 Date: Oct. 27, 2008

(30) Foreign Application Priority Data
May 19, 2005 (DE) 102005022908.5

(51) Int. Cl. G01N 27/22

(52) U.S. Cl. 73/73

(57) ABSTRACT

Installation for moisture detection for motor vehicles comprised of an oscillator, a resonant circuit (1) and a measuring and analysis circuit, where the resonant circuit (1) contains an inductance (12) and a capacitance (11) and where the inductance (12) and the capacitance (11) are separate components.

### PRIOR ART

The subject matter of the invention is an installation for moisture detection for motor vehicles comprising an oscillator, a resonant circuit and a measuring and analysis circuit where the resonant circuit has an inductance and a capacitance. The subject matter of the invention is also a configuration comprising a window of a motor vehicle, especially a windshield, and an installation for moisture detection of the aforementioned type.

Such installation and configuration of the aforementioned type is known from the publication number DE 101 27 990 C2. The configuration is able to detect moisture on a windshield. This so-called rain sensor can be used to control a windshield wiper.

The prior art normally uses the parasitic capacitance of the inductance as the capacitance in the resonant circuit of the installation for moisture detection, the benefit being that a separate capacitance is not required. The inductance is usually attached to or integrated into the windshield somewhere behind the rear-view mirror. When the outside of the windshield glass becomes wet, the capacitance will change leading to the resonant circuit being detuned. Detuning of the resonant circuit can be registered by the measuring and analysis circuit. The surface area of the windshield available for moisture detection is comparatively small. Since the inductance is not transparent it can only be installed in areas—such as behind the rear-view mirror—outside the windshield area that the vehicle driver must be able to see through.

The very small area available for installation of the resonant circuit may, however, not always be representative of the actual level of wetness on the vehicle's windshield. In the past, this sometimes led to an unpredictable response of windshield wiper control.

Taking into account this disadvantage of the prior art, the present invention is faced with the problem of improving an installation of the aforementioned kind such that the installation will cover a larger area of a vehicle's windshield and possibly allow it to be placed in the part of the windshield that the vehicle driver must be able to see through.

### ADVANTAGES OF THE INVENTION

The invention addresses this problem by not using the parasitic capacitance of the inductance as the capacitance of the resonant circuit but instead introducing a separate component as the capacitance where the newly introduced component is separate from yet electrically connected to the inductance.

According to the invention, the capacitance can be made up of two meandering wires of meshing loops. Changing the distance between wires is the means of adjusting the capacitance and also the sensitivity of the installation. As a specific option, the distance between the wires can be adapted to the thickness of the vehicle's windshield. The distance, that is to say, the capacitance of the capacitor should be chosen such that the electromagnetic field extends beyond the surface of the windshield a little in order to be able to detect moisture on the one outer surface of the windshield. The electromagnetic field must not, however, extend so far beyond the surface of the windshield that leaves or similar objects blown across the windshield would change the capacitance.

Moreover, the distance between the wires will also be crucial to the capacitance, that is to say the sensitive area of the installation according to the invention, being transparent or not. Given that the distances are large enough it will very well be possible to see through the sensitive area.

The two wires of the capacitance are preferably connected to the inductance.

The capacitance, and the wires of the capacitance in particular, are flat and can cover an area of 0.5 cm² to 4000 cm², i.e., the surface area detectable by the installation according to the invention can spread across between 0.5 cm² and 4000 cm².

The wires of the capacitance including the wires to the capacitance can be made of a transparent conducting oxide (TCO), for example indium tin oxide (ITO).

There is also the possibility that the wires of the capacitance and the wires connecting the inductance and the capacitance are made of silver, copper or other conducting materials.

A configuration according to the invention, consisting of a vehicle window, particularly a windshield, and an installation of the aforementioned kind can be designed such that the inductance is located in a first area of the vehicle window and the capacitance is located in a second area of the vehicle window with the second area being larger than the first area. In this design, the second area may overlap the first area.

In a configuration according to the invention, the resonant circuit of the installation for moisture detection according to the invention can be installed inside the vehicle window.

The inductance of the resonant circuit can be connected to a second inductance located on the outside of the vehicle window which connects the resonant circuit with the oscillator and the measuring and analysis circuit in a loosely inductive manner, i.e., in a way that its coefficient of coupling is smaller than 0.5.

### DRAWINGS

The drawings give a detailed view of an embodiment of an installation for moisture detection for motor vehicles according to the invention and a configuration according to the invention, comprising a vehicle window and such installation for moisture detection. The following is shown:

FIG. 1 shows the block diagram of a resonant circuit of the installation;

FIG. 2 shows a top view of a resonant circuit of the installation; and

FIG. 3 shows a cross-section through the configuration according to the invention.

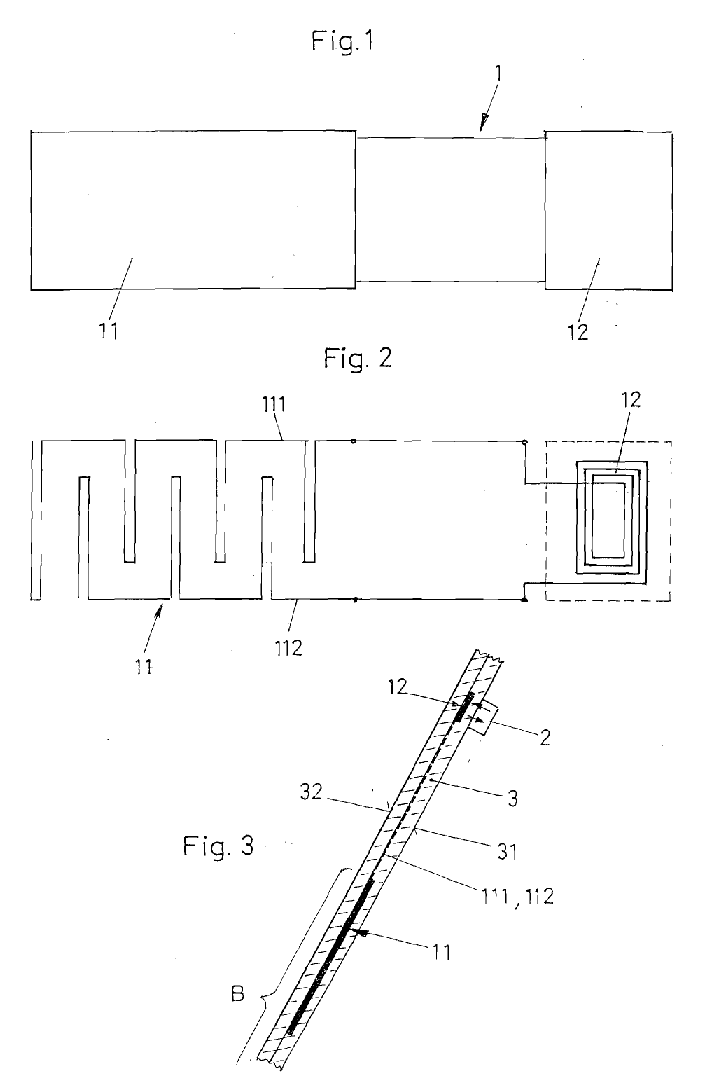

### DESCRIPTION OF EMBODIMENTS

The resonant circuit 1 of the installation for moisture detection for motor vehicles according to the invention differs from installations of this kind known from the prior art in that it comprises an inductance 12 and a capacitance 11 where the inductance 12 and the capacitance 11 are separate components or, in other words, separate structures in terms of design. Inductance 12 is mainly designed in the same way that is known from previous installations of this kind.

However, unlike the prior art, the capacitance of the resonant circuit 1 does not use the parasitic capacitance of the inductance 12 but the capacitance 11 which is separate and can be up to one meter away from the inductance 12.

The capacitance 11 is made up of two separate meandering wires 111, 112 of meshing loops. This kind of setup is also referred to as a comb layout where the “teeth” of the one comb of the one wire 111, 112 reach into the spaces between the teeth of the comb of the other wire 112, 111. The distance between the wire sections of the two separate wires 111, 112 allow the strength of the capacitance and the level of transparency of the component to be adjusted.

The meandering wires 111, 112 are attached to the connectors of the coil to produce a resonant circuit as a result.

The resonant circuit made up of the coil or inductance 12 and the capacitance 11 is installed between two layers of a pane of compound glass 3. On one outside surface, i.e. on the outside 31 of the compound glass or vehicle window 3 that faces the inside of the vehicle, there is a housing containing the oscillator that generates the resonant circuit 11, 12 and a measuring and analysis circuit. The oscillator on the one hand and the measuring and analysis circuit on the other are loosely and inductively connected to the inductance 12 of the resonant circuit 1 via a second inductance installed in the housing. In this context, loosely connected means that the coefficient of coupling is lower than 0.5. Both types of wire, that is to say, the wire connecting inductance 12 and capacitance 11 and the wire making up capacitance 11, are made of a transparent conducting oxide (TCO). Consequently, even if these wires are kept a very short distance apart from one another, they can be installed in an area that the driver must be able to see through. This will leave a much greater degree of freedom of deciding where in the windshield the capacitance is actually installed. Installation is no longer limited to the area near the rear-view mirror.

1. Installation for moisture detection for motor vehicles comprised of an oscillator, a resonant circuit (1) and a measuring and analysis circuit, where the resonant circuit (1) contains an inductance (12) and a capacitance (11), characterized in that the inductance (12) and the capacitance (11) are separate components.

2. Installation of claim 1, characterized by the capacitance (11) being made up of two meandering wires (111, 112) of meshing loops.

3. Installation of claim 2, characterized by the two wires (111, 112) of the capacitance (11) being connected to the inductance (12).

4. Installation of claim 1, characterized by the capacitance (11) being flat and covering an area between 0.5 cm² and 4000 cm².

5. Installation of claim 2, characterized by the wires (111, 112) of the capacitance (11) consisting of a transparent conducting oxide (TCO) like indium tin oxide, for example.

6. Installation of claim 2, characterized by the wires (111, 112) of the capacitance (11) consisting of silver, copper or other conducting materials.

7. Configuration of a vehicle window (3) and an installation for moisture detection as in one of claim 1, characterized by the inductance (12) being installed in a first area of the vehicle window (3) and the capacitance (11) being installed in a second area of the vehicle window (3) with the second area being larger than the first area.

8. Configuration of claim 7, characterized by the second area covering the first area.

9. Configuration of claim 7, characterized by the resonant circuit (1) being installed inside the vehicle window (3).

10. Configuration of claim 9, characterized by the inductance (12) of the resonant circuit (1) being connected to a second inductance located on the outer surface (31) of the vehicle window (3) which second inductance loosely and inductively connects the resonant circuit (1) with the oscillator and measuring and analysis circuit.
